(19) United States
(12) Patent Application Publication
(10) Pub. No.: US 2008/0147742 A1
(43) Pub. Date: Jun. 19, 2008

(54) Method and system for evaluating evaluators

(76) Inventor: Chris Allen, Murray, KY (US)

Correspondence Address: STOCKWELL & SMEDLEY, PSC, 861 CORPORATE DRIVE, SUITE 200, LEXINGTON, KY, 40503, US

(21) Appl. No.: 11/999,826

(22) Filed: Dec. 7, 2007

Related U.S. Application Data
(60) Provisional application No. 60/874,473, filed on Dec. 13, 2006.

(51) Int. Cl. G06F 17/30

(52) U.S. Cl. 707/104.1; 707/E17.009

(57) ABSTRACT

A system or method presents a plurality of content items to each of a plurality of users and receives an evaluation score for each item from each user. An average score for each item is calculated and then, for each user, a composite variance score is calculated. The composite variance score is the sum of the absolute value of the difference between a user's score for an item and the population's average score for that item. The evaluators' performance and the items' rankings can be used for additional information and purposes.

### RELATED APPLICATIONS

The present application claims priority to Provisional Patent Application Ser. No. 60/874,473 filed Dec. 12, 2006, the contents of which are incorporated herein by reference in their entirety.

### BACKGROUND

1. Field

The present invention relates generally to rating various types of media and, more particularly, comparing the performance of different raters.

2. Description of Related Art

Recently social networking sites have gained popularity as a way for online communities to develop. This phenomenon allows individuals with similar tastes or some other common attribute to share information, socialize virtually, and interact with one another and various forms of media.

The Internet has also spawned a variety of sites that allow users to rank or rate items and to share those rankings with other users. Retailers and other sites also can use such ratings to predict what may be of interest to a particular user. For example, the demographic information about a user may be utilized to identify items or products that other users with similar demographics rated highly. Thus, a particular book, song, or Christmas gift may be recommended by a site with that recommendation tailored based on information or behavior about the user or other similar users. Also, artists can be given feedback on their creative works which they may publish to a rankings or ratings site.

Because of the anonymity provided by the Internet, there has been some concern in some instances whether customer ratings can be trusted. Accordingly, some sites allow raters of products to be ranked by other users. In this way, certain raters are identified as being “trustworthy.” In such cases, recommendations by the trustworthy users may be given more weight than a recommendation by a less trustworthy rater.

There remains a number of unsolved problems with these existing systems that provide many opportunities for improvement and additional benefits. Thus, in addition to the traditional systems as described above, there remains the unfulfilled need of a system and method that combines aspects of social networking and product rankings in a way that is fun and attractive to both the users making the ratings and to the companies that control the products.

### BRIEF SUMMARY OF THE INVENTION

Embodiments of the present invention relate to a system and method for presenting a plurality of content items to each of a plurality of users and receiving an evaluation score for each item from each user. An average score for each item is calculated and then, for each user, a composite variance score is calculated. The composite variance score is the sum of the absolute value of the difference between a user's score for an item and the population's average score for that item.

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF DRAWINGS

FIG. 1 depicts a flowchart of an evaluator evaluation method in accordance with the principles of the present invention.

FIG. 2 depicts a block diagram of a system configurable to implement the method of FIG. 1.

FIG. 3 depicts a detailed flowchart of a specific example of a multi-round contest in accordance with the principles of the present invention.

### DETAILED DESCRIPTION OF INVENTION

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

As described below, a user may provide ratings or rankings about a variety of different products or items. For consistency, the term “product” will often be used herein refer to the wide range of items that may be rated and is not intended to limit applications of embodiments of the present invention to only certain types of commercial products. For example, “products” is intended to encompass substantially any media that can be ranked or rated by a plurality of different users. Examples include: songs, books, articles, fashion items, clothes, advertisements, videos, images, political speech, social speech, physical items (e.g., cars, curtains, watches, etc.). As will be explained further herein, some of these products are better suited for various aspects of different embodiments of the present invention. Products may be grouped at different granular levels. For example, a “song” product, which is too general, will not produce as meaningful results as generated by separating songs into different genres which are evaluated separately (preferably by different sets of evaluators).

In addition, the terms “evaluating”, “scoring”, “ranking” and “rating” may be used interchangeably to refer to the same type of activity. Because “ranking” generally means putting items in an ordered list according to some score, it inherently encompasses assigning a score (or a “rating”) to each of the items in that ordered list. Thus, as used herein, evaluating, scoring, ranking and rating all intend to encompass assigning a rating score to an item.

One of ordinary skill will recognize that the specific format of the rating score may vary dramatically without departing from the scope of the present invention. For example, some specific examples provided later are described as having a rating score for each item being a number between 000 and 999. In general though, any type of differential scoring can be used to rate an item. Examples include a “star” system in which the user assigns a number of stars to an item, or a letter system similar to academic grades where an “A” and an “F” are on opposite ends of the scoring spectrum. The digits of a numeric score may also be limited in range (e.g., 1-5 instead of 0-9) or there may be more or less digits than the three illustrated above. It is beneficial that whatever scoring mechanism is ultimately used, that it be sufficient to indicate gradations of differences between the different items being scored. For example, a binary system (e.g., approve/disapprove) may not be sufficient to accurately reflect that there are degrees, or gradations, of how much a user may like or dislike an item.

Even within a numeric score, the numbers may have different meanings. For example ranking a song as a “506” may mean that overall the rater was fairly neutral about the song. The score will have a different meaning though if the first digit means “lyrics”, the second digit means “danceability”, and the third digit means “overall impression”. In this latter case, the user is clearly not neutral about the “danceability” of the song. One of ordinary skill will recognize that fewer or more categories may be utilized in defining the scoring digits. Similarly, analogous categories may be used for other type of products. For movies the scoring categories may be, for example, “action”, “plot”, “dialogue”, “overall impression”, “artistic qualities”, “soundtrack”, etc. For advertisements the categories may be, for example, “humor”, “jingle”, “memorable”, “effective”, etc. Thus, it is clear that the specific way that scoring is applied and defined may vary without departing from the scope of the present invention.

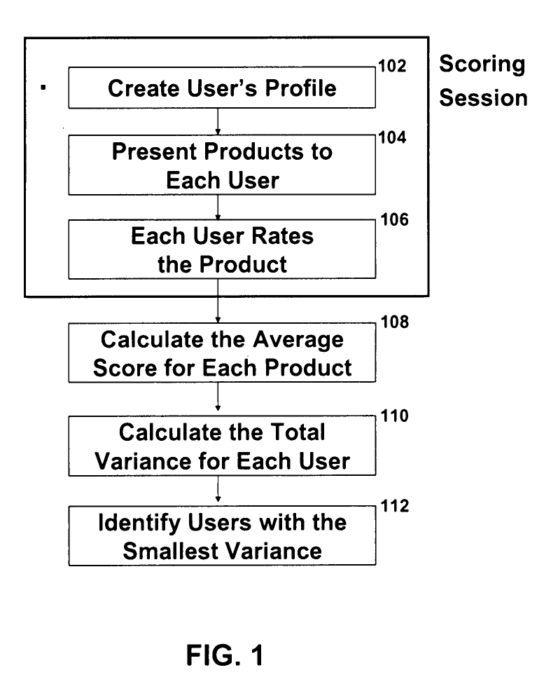

In general, embodiments of the present invention permit a determination to be made about the performance of different users that rank a variety of products as compared to the average population of raters. FIG. 1 depicts a simple flowchart of the basic elements of embodiments of the present invention. In step 102, a user creates a profile in some manner that allows that user to be identifiable. This profile can also include demographic information. In step 104, a number of products are presented to the user to be rated. The user then rates each item using an appropriate scoring definition, in step 106. A scoring session, or evaluation session, includes a plurality of different users rating the same set of products. While it is possible that a set of products include only a single product, including multiple products in the set will beneficially affect the ability to distinguish amongst different raters.

Once a scoring session is complete an average score may be calculated, in step 108, for each item. The average score is straightforward to calculate when the scoring definition is numeric; if, however, the scoring definition is some other type (e.g., “A” through “F”), then some type of conversion to an equivalent number may be needed before calculating an average. The average is calculated with a precision that is based on the expected population size of raters. For example, if 10 raters are anticipated as compared to 10,000,000 raters, then less precision is needed.

In step 110, a composite variance score is calculated for each user. This composite variance score is comprised of the individual variances for each of the products rated during the scoring session. This variance for each product is the difference between the user's rating for that product and the product's average score. More precisely, it is the absolute value of this difference. Thus, all the magnitudes of each the variances for a user can be simply summed to arrive at the composite variance score for each user. In step 112, the user with the lowest variance can be identified as the “winner” and all users or evaluators can be ranked based on their ability to match the population; also, a subset of the top users can be identified as well. This specific measure of variance is provided only by way of example and one of ordinary skill will recognize that there are other accepted techniques for measuring how closely a particular user's rating scores match those of the overall population. Thus, other measures of variance are contemplated within the scope of the present invention.

Along with the evaluators or users with the best scores being identified, the top ranked product or products can be identified as well. Thus, a variety of information becomes available for additional purposes. For example, the winner is recognized as a person who accurately reflects a larger population's view on the genre of products used in the scoring session. This type of person may be attractive for future marketing purposes as the winner's opinion may be predictive of how a larger population will react to future products. Also, the users can be ranked according to their variances so that an opinion from a user with a lower variance may be given more value than one with a higher variance. Information about the products themselves is generated so that a supplier of those products may determine which are ranked higher by the population. Within a social networking environment, the demographic information and the rankings may be used to identify like-minded people whom a user may wish to add to their circle of friends. Also, the demographic information may be utilized by the product suppliers to gauge public response for different groups within a population. The evaluation of political messages, advertisements, video games, etc. may all be analyzed according to raw rankings but also according to select demographic groups.

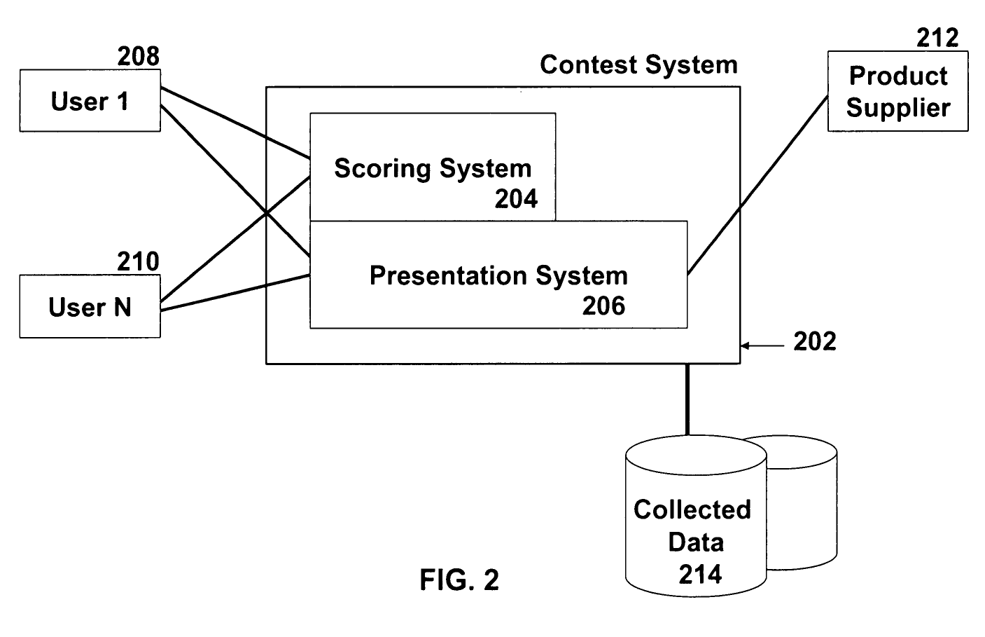

FIG. 2 depicts a high-level view of a system for implementing the flowchart of FIG. 1. In particular, a contest system 202 provides a scoring system 204 and a presentation system 206. The presentation system 206 presents the products that are received from the product suppliers 212. For example, the product suppliers may be artists (e.g., singers, bands, writers, illustrators, videographers, etc.) that make their content available to the contest system 202 to gain exposure and recognition. The product suppliers 212 may also be advertisers providing a number of competing ads or record labels providing new songs in order to gauge public opinion. Other potential products are political campaign messages, news articles, or issues of social concern.

In one embodiment, the contest system 202 is a social networking Internet site that a user visits with a typical web browser. The products are presented from within the site or a link to another site. The user provides scores using the web browser. This specific embodiment provides a number of benefits. First, the site already has registered users so that they are identifiable along with some types of demographic information. Secondly, the user interface to select which scoring session to participate in, to provide the methods of how to display particular products, and to provide the score sheets for receiving scores can be implemented using standard, available systems and software. Thirdly, the social networking site is already designed for facilitating users with similar likes and dislikes to locate one another and socialize. In such a system, the input, output, scoring, ranking, calculating, and displays are all performed by general computers that are appropriately programmed to accomplish these tasks.

However, the scoring system 204 and the presentation system 206 are shown as separate components because other embodiments of the present invention may utilize distinct and separate components. For example, the presentation system 206 may be broadcast television in which a contestant's performance on a show is being rated by different raters. The scoring system 204 may be a web site dedicated to that show or a combination of web site, text messaging, and telephone response means through which the raters provide their scores.

The users 208, 210 interact with both the presentation system 206 and the scoring system 204. As described earlier with respect to FIG. 1, each user is shown the products that will be scored; they will rate them, and then at the close of the scoring session, an evaluation of the evaluators is calculated and revealed. The user's can interact with the scoring system 204 and presentation system 206 in various ways such as through web browser's, telephone's mobile devices, television, etc. As shown in FIG. 2, the various data 214 collected along the way is stored for use by various parties.

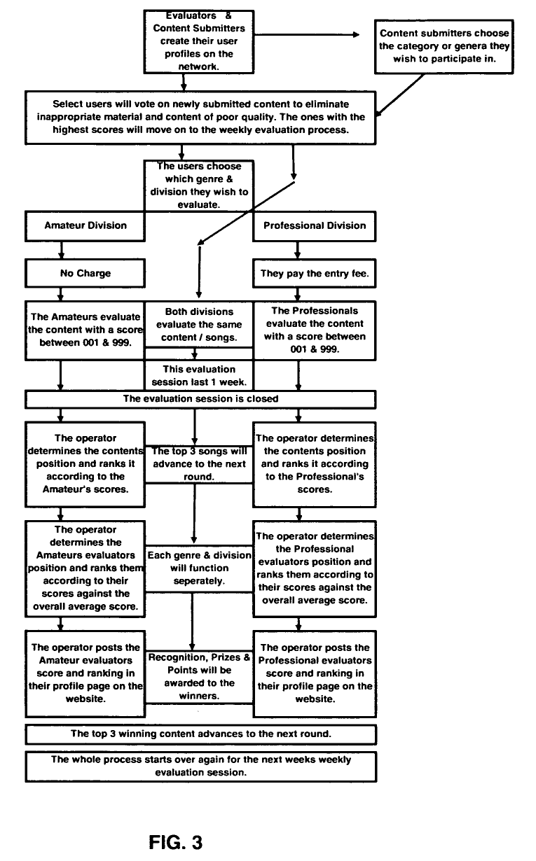

One specific implementation of an embodiment of the present invention organized as a contest having different divisions of users is depicted in FIG. 3. One of ordinary skill will readily recognize that fewer or more divisions may be permitted and that the labels “professional” and “amateur” are provided as a specific example not as a limitation. The right side of the flowchart depicts the path for professionals and the left side depicts the path for amateurs.

To become an evaluator the user first creates a user profile in the social network site and then the user registers for evaluation sessions involving the particular musical genres or other content categories they wish to participate in. This allows the operator to calculate the exact number of evaluators who are participating in each evaluation session.

The operator of the system may also perform initial screening using a group of people that will screen out content such as, for example, songs of poor quality and inappropriate material.

Each evaluator will then listen to each of the songs or view the content that is listed in the evaluation session. This content may be submitted by other users and artists seeking exposure and recognition. Through this initial rating process the top songs will advance to the periodic (e.g. monthly) evaluation session. Each evaluation session will have a set number of songs or pieces of content. The evaluation sessions will last a specified period of time such as a particular number of days. When the participants have finished listening to each song or viewing the other content they will rate it with a score of between 000 and 999. With the 000 meaning they liked it the least and the 999 meaning they liked it the most. In one embodiment, an evaluator will not be allowed to give two or more songs or pieces of content the same score. If they do not give it a score it will proceed with the default score of 000. This will cause the evaluator to receive the maximum variance amount on 999 going against their final score. As mentioned earlier, the specific scoring format and definition is not limited to this specific example. In addition, some type of “penalty” score may be used so that if a user fails to rate an item, then they are penalized in some manner that increases their ultimate variance score.

When the evaluation session is closed the operator will know how many users participated, their identities, and the score given each piece of content. The system will add the scores given by the evaluators for each individual song or piece of content together and then divide that total score by the number of evaluators registered to participate in the session. This will determine each song's or piece of content's overall average score. These overall average scores may, for example, be carried out 10 or more decimal places to provide a large degree of precision. One of ordinary skill will recognize that other ways of scaling the scores are possible to provide sufficient differentiation among the users.

With the content's scores and ranking confirmed, the operator can now determine who the best evaluators were as explained with reference to FIG. 1, step 110. As mentioned, the evaluator who scores all of the individual pieces of content with the lowest total variance compared to the overall average (baseline) score will quantitatively be the best at evaluating which individual pieces of content were the most liked and disliked by the majority of evaluators and will be recognized as the best evaluator.

Users benefit because they can evaluate their own skills as raters as compared to the general population or their friends. Users are also able to identify like-mined individuals in the network. Artists benefit from knowing whether a user's comments likely reflect the feelings of the general population or if the user is not representative of the population. Political candidates and parties can identify the demographic that most closely agrees with a position. They can also identify what “spin” of a message or story is received the most favorably or the most negatively. This identification can be aligned with geographic information about the users to determine how a message is received differently in one location as compared to another. Advertisers can first, get more users interacting with their ads and secondly, determine how ads are ranked and which executives or decision makers accurately have a feel for the population's likes and dislikes. Content producers, for example record companies, can identify which new artists are ranked highest but by identifying and utilizing opinions of “good” evaluators, a company can predict whether new content will be favorably received or not.

As mentioned, the operator of the system can create separate content evaluating divisions. For example the first could be an Amateur division. They can listen to or view and then evaluate the content free of charge. There would be a weekly evaluation session in which the winners would be awarded with recognition and possibly prizes. The top evaluators (e.g. 500 or more) would receive points towards the yearly points championship for being the best at evaluating the content in their division. In one example, points would only be awarded in the weekly rounds. There will also be monthly evaluation sessions where the top 3 songs from each of the weekly evaluation sessions advance to be evaluated again in order to determine which the majority of evaluators likes the best. The top three songs or other pieces of content will then advance to the quarterly semi-final. Then the top three songs or other pieces of content from each of those sessions will advance to the Final round to determine the top three songs or other pieces of content of the year. These artists will receive an enormous amount of recognition when their songs or other pieces of content advances in the Amateur division.

In addition, money may be generated from the Professional division. People who participate in the Amateur division can also participate in the Professional division. However in the Professional division the operator will charge the evaluator a fee to evaluate the same content that is in the weekly evaluation sessions that the Amateur division evaluates. Except in the Professional division the evaluators will be competing for a percentage of the total evaluator's entry fees. The professional division will operate in exactly the same way as the Amateur division, having the same number of evaluation sessions. The operator could charge higher amounts for the monthly finals and for the Quarterly semi-finals rounds and then for the Grand finale. The operator could withhold some percentage (e.g., 5%) or more of the weekly evaluator's fees to create the grand prize for the Weekly Points Championship winners. The Artists may submit their songs for free but they will be eligible to win cash and other prizes for having the highest rated songs or content on top of the enormous exposure they receive in both the Amateur and Professional divisions.

Another embodiment that also involves a television show in conjunction with the social network is envisioned as well. The show would draw its initial contestants from its online ranking system such as, for example, its Amateur division or some other group of participants. The televised evaluation sessions would in essence become another division since it would pull its content from the top rated songs from the online genres.

The system operator would operate the weekly evaluation sessions as normal and would announce the winning songs and the six winning evaluators, but would not reveal the exact scores so as not to give anyone an advantage until after the televised evaluation session are completed.

The producers of the television show would pick the best 8 to 10 of the most attractive songs from the most popular genres and arrange for the artists to perform them live on national TV.

There will be no professional judges. The winners will be selected purely by the viewing audience which includes the 6 studio judges. The audience will only be able to rate the songs once per show. Our viewing judges will be rating which artist they feel provides the best entertainment. These evaluators would listen to the songs picked by the producers being preformed live in the studio. They would then score their evaluation of the songs with a score ranging from 000 to 999. The television audience would also be invited to participate along with the live show by logging on and creating a free user profile on the social network site. They would get to interact with the show by scoring their evaluations of the songs with a score of between 000 to 999 online in unison with the show. If they choose to they will have several days to consider their how to score the songs. They will be able to go back to the social network website and re-watch the performances and rate each one at their leisure. Once they have scored all of the performances they can submit their scores.

The winners will be determined in exactly the same way as the online Amateur and Professional divisions are. The top three studio evaluators with the lowest total variance will win cash prizes and get to return to the next week's show. The audience evaluator's scores will be determined in the exact same way as the studio evaluators. Since three of the studio evaluators will be eliminated those studio positions will be filled by the top three rated audience evaluators. Also the top three audience evaluators may be offered some sort of token prize but their real prize will be getting to be flown in to evaluate the songs live on the next week's show.

The winning artists will be determined by averaging both the studio evaluator's scores with the audience's scores. The winning artists will win some type of cash prizes but their real prize will be to earn the enormous amount of television exposure which could quite possibly be much more valuable than the cash prize.

There can then be subsequent rounds where the top 3 performers from each week compete in a monthly finale, then a quarterly and a Grand finale at the end of the season just like the online versions. In the Grand finale the studio judges will be the top 10 or more of these Top Evaluators. The winner of this competition could be win a significant prize.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A rating system comprising:
a memory system storing a respective identification of a plurality of users;
a presentation component configured to present a plurality of items to each of the plurality of users;
a scoring component configured to receive a respective score from each of the plurality of users for each item;
a calculator configured to:
calculate an average score for each item based on the respective scores for that item from each user;
calculate, for each user and for each item, a respective difference between their score for each item and that item's average score; and
calculate a respective composite variance score for each user based on the respective differences for all items for that user; and
an output component configured to identify which of the plurality of users most closely matches the averages scores for each item based on the composite variance score.

2. The system of claim 1, wherein the respective difference is considered as an absolute value.

3. The system of claim 1, wherein the composite variance score comprises a sum of the absolute values of the respective differences.

4. The system of claim 1, further comprising:
an item ranking component configured to rank the items according to the average scores.

5. The system of claim 1, further comprising:
a user ranking component configured to rank the users according to the composite variance scores.

6. The system of claim 1, wherein the items comprise one of: news articles, political messages, songs, videos, literary works, graphical arts, advertisements, and live performances.

7. The system of claim 6, wherein the songs comprise a particular genre of music.

8. The system of claim 1, wherein a respective score is a multi-digit number.

9. The system of claim 8, wherein each digit is associated with a different characteristic appropriate to evaluating the items.

10. The system of claim 1, wherein the presentation component, the memory system, the scoring component, the calculator, the output component are part of a social networking site.

11. A method for rating items, comprising:
presenting each of a plurality of items to each of a plurality of users, wherein the users are uniquely identifiable;
receiving from each of the users a respective score for each of the items;
calculating an average score for each item based on the respective scores received from the users;
calculating, for each user and for each item, a respective difference between their score for each item and that item's average score;
for each user calculating a composite variance score based on the respective differences for that user; and
identifying which of the plurality of users most closely matches the averages scores for each item based on the composite variance score.

12. The method of claim 11, wherein the respective difference is considered as an absolute value.

13. The method of claim 11, wherein the composite variance score comprises a sum of the absolute values of the respective differences.

14. The method of claim 11, further comprising:
ranking the items according to the average scores.

15. The method of claim 11, further comprising:
ranking the users according to the composite variance scores.

16. The method of claim 11, wherein the items comprise one of: news articles, political messages, songs, videos, literary works, graphical arts, advertisements, and live performances.

17. The method of claim 13, further comprising:
awarding a prize to a user having a lowest composite variance score.

18. A method for holding a contest comprising the steps of:
a) registering a plurality of users to evaluate a plurality of items;
b) presenting each of the plurality of items to each of the users;
c) receiving a respective score for each item from each user;
d) determining a subset of users whose set of respective scores most closely matches a set of average scores for the items, wherein the average score for a particular item is based on the respective scores from the plurality of users for that item;
e) awarding a prize to the set of users.

19. The method of claim 18, wherein the subset of users comprise a single user.

20. The method of claim 18, further comprising:
ranking the plurality of items according to the average scores.

21. The method of claim 18, further comprising:
running a subsequent stage of the contest by repeating steps b) through d) wherein the plurality of items in the subsequent stage is limited to a subset of the plurality items in an earlier stage, the subset comprising those of the plurality of items having higher average scores.

22. The method of claim 18, further comprising:
receiving a fee from each of the users along with each set of respective scores.

23. The method of claim 18, wherein the plurality of users include a first division from which scores are received without an accompanying fee and a second division from which scores are received with an accompanying fee.

24. The method of claim 23, wherein a portion of the accompanying fees is awarded to a member of the second division whose set of respective scores most closely matches the set of average scores for the items.

25. A method for holding a contest comprising the steps of:
a) registering a plurality of users to evaluate a plurality of presented items;
b) receiving a respective score for each presented item from each user;
c) determining a subset of users whose set of respective scores most closely matches a set of average scores for the presented items, wherein the average score for a particular item is based on the respective scores from the plurality of users for that presented item;
d) awarding a prize to the set of users.

26. The method of claim 25, wherein the presented items are presented during a television show.

27. The method of claim 26, further comprising:
identifying a most popular one of the presented items based on the average scores.
